(19) United States
(12) Patent Application Publication
(10) Pub. No.: US 2019/0070867 A1
(43) Pub. Date: Mar. 7, 2019

(54) PRINTER

(71) Applicant: TOSHIBA TEC KABUSHIKI KAISHA, Tokyo (JP)

(72) Inventor: Yasuhiro SEKI, Mishima Shizuoka (JP)

(21) Appl. No.: 16/108,035

(22) Filed: Aug. 21, 2018

(30) Foreign Application Priority Data
Sep. 7, 2017 (JP) 2017-172384

(51) Int. Cl. B41J 3/50; B41J 11/00

(52) U.S. Cl. CPC B41J 3/50; B41J 11/009

(57) ABSTRACT

A printer is configured to connect with a detachable ink unit and a printing medium wound around a core, and includes a wireless tag reader and writer configured to communicate with a wireless tag, an input device configured to accept an input from a user, and a controller. When the input device accepts the input for adjusting a setting of the ink unit, the controller controls the wireless tag reader and writer to store in at least one of a first tag included in the ink unit and a second tag included in the core, combination information indicating a combination of the ink unit and the printing medium that are attached to the printer and adjustment information indicating the setting.

### CROSS-REFERENCE TO RELATED APPLICATION

This application is based upon and claims the benefit of priority from Japanese Patent Application No. 2017-172384, filed Sep. 7, 2017, the entire contents of which are incorporated herein by reference.

### FIELD

Embodiments described herein relate generally to a printer.

### BACKGROUND

A conventional label printer may have a function to automatically apply the same setting such as a print density associated with a certain combination of a print label and an ink ribbon. To achieve this function, the label printer via an IC chip reader communicates with two IC chips each disposed on the core of a strip label and the supply reel of an ink ribbon, and identifies the types of the label and the ink ribbon using the IDs assigned to them. Once these types have been identified, the label printer retrieves from a memory a setting predetermined for the combination of the label and the ink ribbon and applies the setting automatically.

Such an automatic configuration about the print density is made for general use. Thus, a user may still need additional adjustments when he or she wants to print labels according to a specific printing policy, e.g., a company policy enforced by the company at which the user works. Moreover, the company user is often required to prepare labels with various combinations of labels and inks under the company policy, which may put heavy burden of re-adjustments to the default setting on the user.

### DESCRIPTION OF THE DRAWINGS

FIG. 1 is a view illustrating an example of an appearance configuration of a label printer of an embodiment.

FIG. 2 is a view illustrating an example of a configuration of a printing mechanism accommodated in an inside of the label printer.

FIGS. 3A and 3B are views illustrating an example of respective configurations of an ink ribbon unit and roll paper.

FIG. 4 is a block diagram illustrating an example of a hardware configuration of the label printer.

FIG. 5 is a diagram illustrating an example of a function realized in a main control unit.

FIGS. 6A and 6B are diagrams illustrating an example of data stored in a first non-contact tag and a second non-contact tag.

FIG. 7 is a flowchart illustrating an example of an operation of the label printer.

FIGS. 8A and 8B are diagrams illustrating an example of data stored in a first non-contact tag and a second non-contact tag of Modification example 1.

FIGS. 9A and 9B are diagrams illustrating an example of data stored in a first non-contact tag and a second non-contact tag of Modification example 2.

### DETAILED DESCRIPTION

An embodiment provides a printer capable of reducing a burden of adjustment of print setting including a print density by a user.

In general, according to one embodiment, a printer is configured to connect with a detachable ink unit and a printing medium wound around a core. The printer includes a wireless tag reader and writer configured to communicate with a wireless tag, an input device configured to accept an input from a user, and a controller. When the input device accepts the input for adjusting a setting of the ink unit, the controller controls the wireless tag reader and writer to store in at least one of a first tag included in the ink unit and a second tag included in the core, combination information indicating a combination of the ink unit and the printing medium that are attached to the printer and adjustment information indicating the setting.

Hereinafter, an embodiment of a printer will be described in detail with reference to the drawings. An embodiment provides a thermal transfer type label printer. Here, an “ink unit” is also referred to as an “ink ribbon unit”. The “ink unit” also includes parts that are detached together with ink. In addition, “roll paper” is illustrated as a “printing medium”. The “printing medium” is, for example, a sheet of paper, a film, or the like for printing of print data (also including an image). The “printing medium” is not limited to a roll-like wound medium and may be a long sheet or the like.

### Embodiments

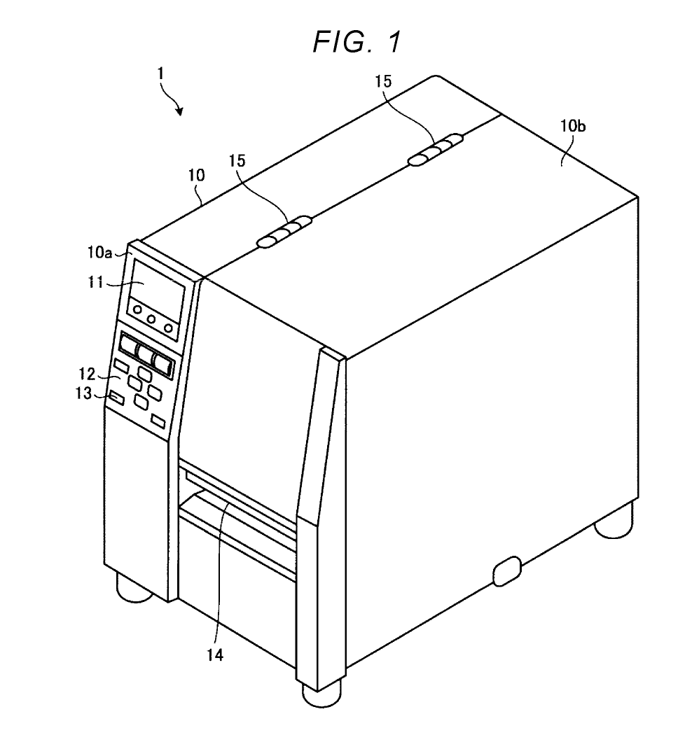

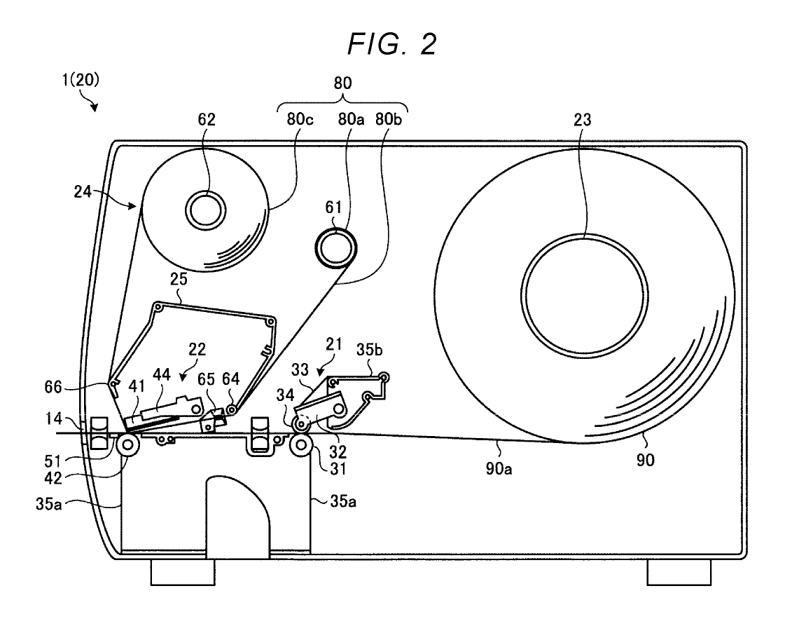

FIG. 1 is a view illustrating an example of an appearance configuration of a label printer of an embodiment. A label printer 1 illustrated in FIG. 1 includes a front panel 10a in a housing 10 and the front panel 10a is provided with a display unit 11 and an operation unit 12. The display unit 11 is a display device such as a liquid crystal display. The operation unit 12 includes operation buttons 13 which are, for example, operation buttons for mode selection, operation buttons for instructing up, down, left, or right, and the like. The label printer 1 includes a printing mechanism 20 (see FIG. 2) on the inside thereof, and a label after printing is issued from a label issuing port 14 provided in a half side 10b of the housing 10.

The label printer 1 has a structure in which the printing mechanism 20 accommodated in the housing 10 is exposed by lifting the half side 10b of the housing 10 with two hinges 15 as fulcrums. An ink ribbon unit 80 (see FIG. 2) and roll paper 90 (see FIG. 2) which are set in the printing mechanism 20 are detachable, and in the label printer 1 of an embodiment, the change can be made by lifting the half side 10b.

Various connectors such as a Universal Serial Bus (USB), a Local Area Network (LAN), and RS232C are disposed on a panel of a back surface of the housing 10.

FIG. 2 is a view illustrating an example of a configuration of the printing mechanism 20 accommodated in the inside of the label printer 1. As illustrated in FIG. 2, the printing mechanism 20 includes a sheet carrier 21, a printing unit 22, a sheet holder 23, an ink ribbon supply device 24, a guide frame 25, and the like.

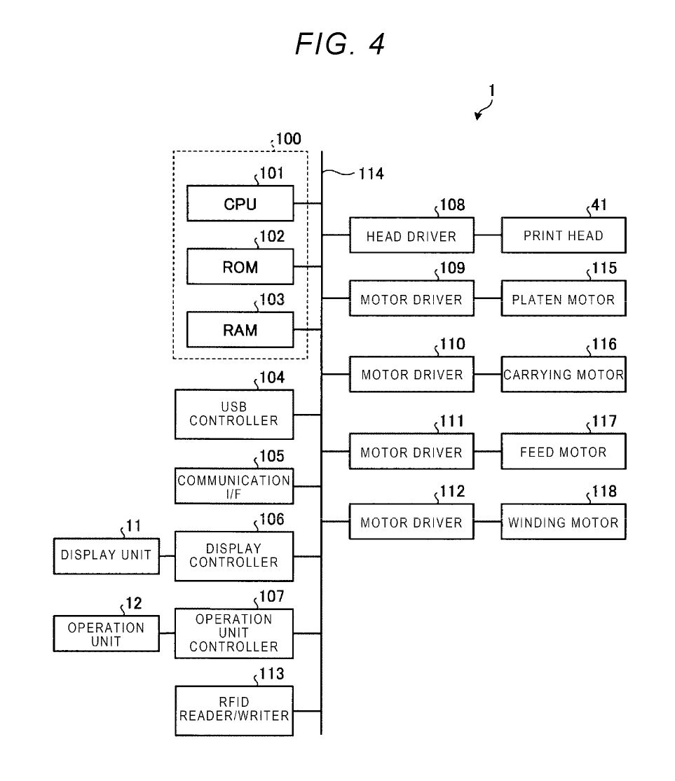

The sheet carrier 21 includes a sheet carrying roller 31, a support unit 32, a leaf spring 33, and a pinch roller 34. The sheet carrying roller 31 is rotatably attached to a frame 35a and is rotated by power of a carrying motor 116 (see FIG. 4).

The support unit 32 is swingably attached to a frame 35b and supports the pinch roller 34 at one end. The pinch roller 34 is rotatably attached to one end of the support unit 32. One end is attached to the frame 35b and the other end of the leaf spring 33 abuts against the pinch roller 34. However, the pinch roller 34 is urged by the leaf spring 33 and is pressed by the sheet carrying roller 31.

The printing unit 22 includes a print head 41 and a platen 42. The print head 41 is fixed to a head holder 44 rotatably attached to the guide frame 25. The print head 41 is a line type thermal printer head having a heating body. The platen 42 is rotatably attached to the frame 35a and is rotated by power of a platen motor 115 (see FIG. 4).

A label peeling plate 51 is provided as an optional label peeling module in the vicinity of the label issuing port 14. The label peeling plate 51 bends a label sheet 90a immediately before discharging from the label issuing port 14, peels a label from a backing sheet of the label sheet 90a, and discharges a peeled label from the label issuing port 14. The backing sheet from which the label is peeled off is wound around a winding shaft (not illustrated). Not only the label peeling module but also a cutter module or the like may be provided.

The sheet holder 23 is a shaft for holding the roll paper 90. The roll paper 90 is formed by winding the label sheet (label with the backing sheet) 90a around a core. The roll paper 90 is rotatably held by the shaft which is the sheet holder 23 by being mounted through the core of the roll paper 90. The label sheet 90a drawn out from the end portion of the roll paper 90 passes between the sheet carrying roller 31 and the pinch roller 34, and is sent toward a printing unit 22 side by the rotation of the sheet carrying roller 31 and the pinch roller 34. In the printing unit 22, the label sheet 90a passes between the platen 42 and the print head 41, and is fed to the label issuing port 14, and a label peeled off from the label sheet 90a is discharged to the outside of the housing 10.

The ink ribbon supply device 24 includes a ribbon holding shaft 61 and a ribbon take-up shaft 62 which are driven by a double-drive system. The ribbon holding shaft 61 holds an unused ribbon 80a in the ink ribbon unit 80 and is rotated by power of a feed motor 117 (see FIG. 4). An ink ribbon 80b drawn out from the unused ribbon 80a is rotated around the guide frame 25 and is wound around the ribbon take-up shaft 62. The ribbon take-up shaft 62 is rotated by power of a winding motor 118 (see FIG. 4) and recovers a used ribbon 80c from which the ink is peeled off after the print head 41 transfers the ink to the label sheet 90a.

The guide frame 25 is provided with a guide roller 64 that guides the ink ribbon 80b drawn out from the ribbon holding shaft 61. The guide roller 64 is rotatably provided in the guide frame 25. After the ink ribbon 80b is led to the guide roller 64, the ink ribbon 80b passes through a ribbon end sensor 65 which detects the end of the ink ribbon 80b, and is led between the print head 41 and the platen 42. The ink ribbon 80b is heated by the print head 41 between the print head 41 and the platen 42, and the ink of the ink ribbon 80b is transferred to the label of the label sheet 90a. After the ink is peeled off, the ink ribbon 80b is guided to the ribbon take-up shaft 62 side by a guide unit 66 of the guide frame 25 as the used ribbon 80c, and is wound around the ribbon take-up shaft 62.

Moreover, although not illustrated, in addition to the configuration, a sensor that detects a position of the label sheet 90a or the like is disposed on a carrying path.

Subsequently, the ink ribbon unit 80 and the roll paper 90 will be described. There are many combinations of the ink ribbon unit 80 and the roll paper 90. For example, there are various options about the width of the rink ribbon, e.g., 60 mm, 90 mm, and 110 mm. There are also various options about a material of the label, e.g., “resin” and “semi-resin”. The roll paper 90 also has options including paper type labels, such as high quality paper, coated paper, and mirror coated paper, as well as synthetic paper type labels and film type labels. If they conform to the specifications of the label printer 1, the ink ribbon unit 80 and the roll paper 90 can be set in the printing mechanism 20 in any type of combination and used.

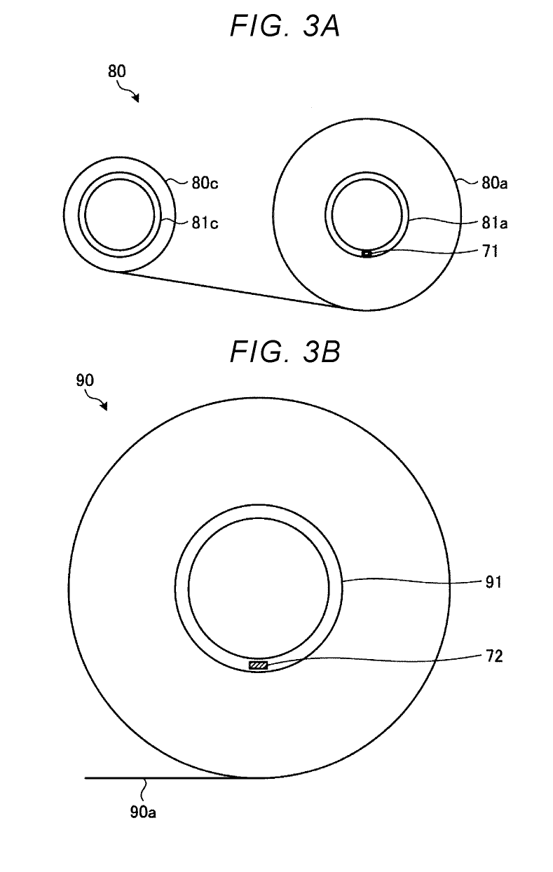

FIGS. 3A and 3B are views illustrating an example of respective configurations of the ink ribbon unit 80 and the roll paper 90. FIG. 3A illustrates an example of the configuration of the ink ribbon unit 80 and FIG. 3B illustrates an example of the configuration of the roll paper 90.

As illustrated in FIG. 3A, the ink ribbon unit 80 includes the unused ribbon 80a wound around a core 81a and a core 81c around which the used ribbon 80c is wound, and has a tag 71.

In an embodiment, the tag 71 is a Radio Frequency Identification (RFID) tag such as a label tag and communicates with an RFID reader/writer 113 (see FIG. 4). For example, the tag 71 is disposed inside of the first core 81a, in a layer at a boundary between the first core 81a and the unused ribbon 80a, in an edge area in which the first core 81a is exposed to the outside, or the like. In an embodiment, the tag 71 is disposed in the first core 81a. Alternatively, the tag 71 may be disposed at another position in the ink ribbon unit 80, or disposed in the second core 81c.

As illustrated in FIG. 3B, the roll paper 90 is formed by winding the label sheet 90a around a core 91 and has a tag 72.

Similar to the tag 71, the tag 72 communicates with the RFID reader/writer 113. For example, as illustrated in FIG. 3B, the tag 72 is disposed inside of the core 91. The tag 72 may be disposed in a place other than the above, for example, in the label sheet 90a on a base side of the core 91 which is not used for printing, or the like.

Each of the tags 71 and 72 includes a Central Processing Unit (CPU) and a memory, and the tags, which can freely write and rewrite data in the memory, are used. In an embodiment, each of the tags 71 and 72 includes an Integrated Circuit (IC) having the CPU and the memory, and an antenna. The antenna acquires power necessary for an operation of the IC by an electromagnetic induction action of a radio wave transmitted from an antenna of the RFID reader/writer 113, and further performs receiving of a command or data transmitted from the RFID reader/writer 113, and transmission of data to the RFID reader/writer 113. The CPU performs a process such as reading or writing for the memory in accordance with the command transmitted from the RFID reader/writer 113. For example, in a case of a write command, the CPU performs writing of the transmitted data in the memory. In addition, in a case of a read command, the CPU reads data from the memory and transmits the data to the RFID reader/writer 113.

Next, a hardware configuration of the label printer 1 will be described. FIG. 4 is a block diagram illustrating an example of the hardware configuration of the label printer 1. As illustrated in FIG. 4, the label printer 1 has a main control unit 100 (CPU 101, ROM 102, and RAM 103) that controls the entire label printer 1.

The CPU 101 is a central processing unit and executes a control program of the ROM 102 to comprehensively control each unit of the hardware. The ROM 102 is a nonvolatile memory that stores various programs and various data. Various data include predetermined print setting information and the like. The RAM 103 is a volatile memory that is used as a work area by the CPU 101.

Here, the predetermined print setting information is a basic setting corresponding to a combination of the ink ribbon unit 80 and the roll paper 90, which is set in advance on the label printer 1 side. The setting includes various basic settings used for determining printing conditions such as setting of a print density and setting of a print speed.

The main control unit 100 is connected to a USB controller 104, a communication Interface (I/F) 105, a display controller 106, an operation unit controller 107, a head driver 108, a motor driver 109, a motor driver 110, a motor driver 111, a motor driver 112, the RFID reader/writer 113, and the like via a bus 114. In addition, although not illustrated, for example, the main control unit 100 is connected to various sensors, the ribbon end sensor 65 (see FIG. 2), and the like on the carrying path.

The USB controller 104 controls a USB memory to be connected. The print data or the like is stored in the USB memory.

The communication I/F 105 is a communication interface such as a LAN and communicates with a host computer (not illustrated).

The display controller 106 displays screen information on the display unit 11 based on an instruction from the main control unit 100. The operation unit controller 107 accepts an input operation from the operation unit 12 and outputs an input command or data to the main control unit 100.

The head driver 108 controls the print head 41 to thermally transfer the ink of a print image to the label of the label sheet 90a. The adjustment of the print density is performed by controlling a temperature of a heating body by controlling a current value flowing through heating body of the print head 41 by the head driver 108.

The motor driver 109, the motor driver 110, the motor driver 111, and the motor driver 112 respectively drive the platen motor 115, the carrying motor 116, the feed motor 117, and the winding motor 118.

Specifically, the platen motor 115 drives the platen 42 (see FIG. 2) to rotate. The carrying motor 116 drives the sheet carrying roller 31 (see FIG. 2) to rotate. The feed motor 117 and the winding motor 118 are motors for double-driving the ink ribbon unit 80, the feed motor 117 drives the ribbon holding shaft 61 (see FIG. 2) to rotate, and the winding motor 118 drives the ribbon take-up shaft 62 (see FIG. 2) to rotate. Each of the motors 115, 116, 117, and 118 is, for example, a stepping motor.

The RFID reader/writer 113 communicates with the tag 71 and the tag 72 and reads data from the respective memories of the tag 71 and the tag 72 and writes data to the respective memories of the tag 71 and the tag 72. Moreover, the antenna of the RFID reader/writer 113 is disposed in the label printer 1 so as to include each of the tag 71 and the tag 72 of the ink ribbon unit 80 and the roll paper 90 to be mounted in a communication range.

Next, a function of the main control unit 100 of the label printer 1 will be described. In the main control unit 100, various functions are realized by executing a program of the ROM 102 by the CPU 101.

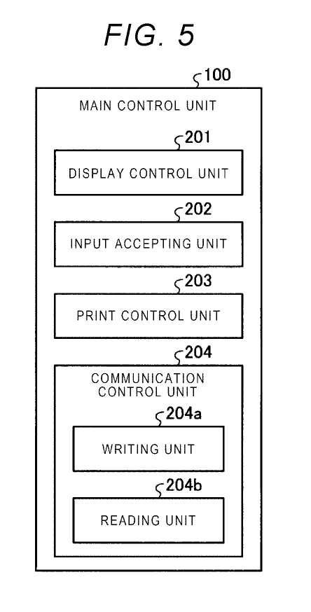

FIG. 5 is a diagram illustrating an example of a function realized in the main control unit 100. A display control unit 201, an input accepting unit 202, a print control unit 203, and a communication control unit 204 are illustrated in FIG. 5 as an example of the function.

The display control unit 201 outputs various kinds of screen information to the display controller 106. The input accepting unit 202 accepts a command or input data specified by an operation of the operation button 13 from the operation unit controller 107.

The print control unit 203 executes an operation relating to printing, density adjustment, or the like which will be described later according to a program list of the ROM 102.

The communication control unit 204 controls the RFID reader/writer 113. Specifically, the communication control unit 204 controls the RFID reader/writer 113 as a writing unit 204a and writes fine adjustment information which will be described later on the tag 71 (or the tag 72). In addition, the communication control unit 204 controls the RFID reader/writer 113 as a reading unit 204b and reads identification information and the fine adjustment information which will be described later from the tag 71 (or the tag 72).

### Setting of Fine Adjustment

Next, fine adjusting of the print setting using the tag 71 and the tag 72 will be described. First, data stored in the tag 71 and the tag 72 will be described and then a processing flow of the fine adjusting will be described.

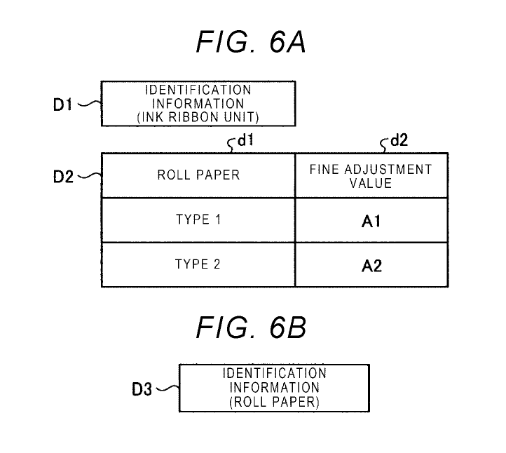

FIGS. 6A and 6B are diagrams illustrating an example of data stored in the tag 71 and the tag 72. Configurations of data stored in the tag 71 and the tag 72 are illustrated in FIGS. 6A and 6B respectively. FIG. 6A illustrates the configuration of the data stored in the tag 71 and FIG. 6B illustrates the configuration of the data stored in the tag 72.

As illustrated in FIG. 6A, the tag 71 of the ink ribbon unit 80 stores identification information D1 and fine adjustment information D2 of the ink ribbon unit 80.

In FIG. 6A, the identification information D1 is identification information indicating a type of the ink ribbon unit 80 attached to the tag 71. For example, as the identification information D1, a code such as a model number is used. For example, the identification information D1 may be stored in advance in the tag 71 before the ink ribbon unit 80 is shipped from the manufacturer. Alternatively, when the ink ribbon unit 80 is mounted on the label printer 1, the label printer 1 acquires the identification information D1 from the ink ribbon unit 80 and stores it in the tag 71. In an embodiment, the former will be described.

The fine adjustment information D2 is information obtained by combining identification information d1 (for example, the model number or the like) indicating the type of the roll paper 90 mounted in combination with the ink ribbon unit 80 with respect to the label printer 1, with a value (fine adjustment value) d2 indicating a positive or negative adjustment width of the print density finely adjusted by using a function of a setting mode by a user in a state where the ink ribbon unit 80 and the roll paper 90 are mounted. When a new combination of the roll paper 90 and the ink ribbon unit 80 is mounted, fine adjustment information is registered for the roll paper 90 of the new combination by a process which will be described later.

FIG. 6A illustrates an example of registration when a fine adjustment value is registered up to two types of the roll paper 90 in the fine adjustment information D2. A fine adjustment value “A1” is associated with one in which a type of the roll paper 90 is a “type 1”. A fine adjustment value “A2” is associated with one in which a type of the roll paper 90 is a “type 2”. After that, when another roll paper 90 is mounted, information indicating a correspondence relationship between the roll paper 90 and the fine adjustment value is additionally registered.

In FIG. 6B, identification information D3 is identification information indicating the type of the roll paper 90 to which the tag 72 is attached. For example, as the identification information D3, a code such as the model number is stored. Timing to store the identification information D3 in the tag 72 is the same as that of the identification information D1.

### Operation of Label Printer

In an embodiment, when the label printer 1 is activated by inputting the power supply and initialization is performed, the label printer 1 acquires in advance each identification information of the ink ribbon unit 80 and the roll paper 90, and then displays an operation screen, and waits in an input waiting state. Each identification information about the ink ribbon unit 80 and the roll paper 90 is acquired from the communication control unit 204 by the print control unit 203. The communication control unit 204 causes the RFID reader/writer 113 to transmit each identification information from the tag 71 and the tag 72.

When the ink ribbon unit 80 or the roll paper 90 is changed after activation, the label printer 1 acquires each identification information from the ink ribbon unit 80 and the roll paper 90 after the change, displays the operation screen, and waits in the input waiting state.

Hereinafter, on the premise that the label printer 1 already acquires the identification information about the ink ribbon unit 80 and the roll paper 90 to be mounted, an operation of the label printer 1 for adjusting thereafter will be described.

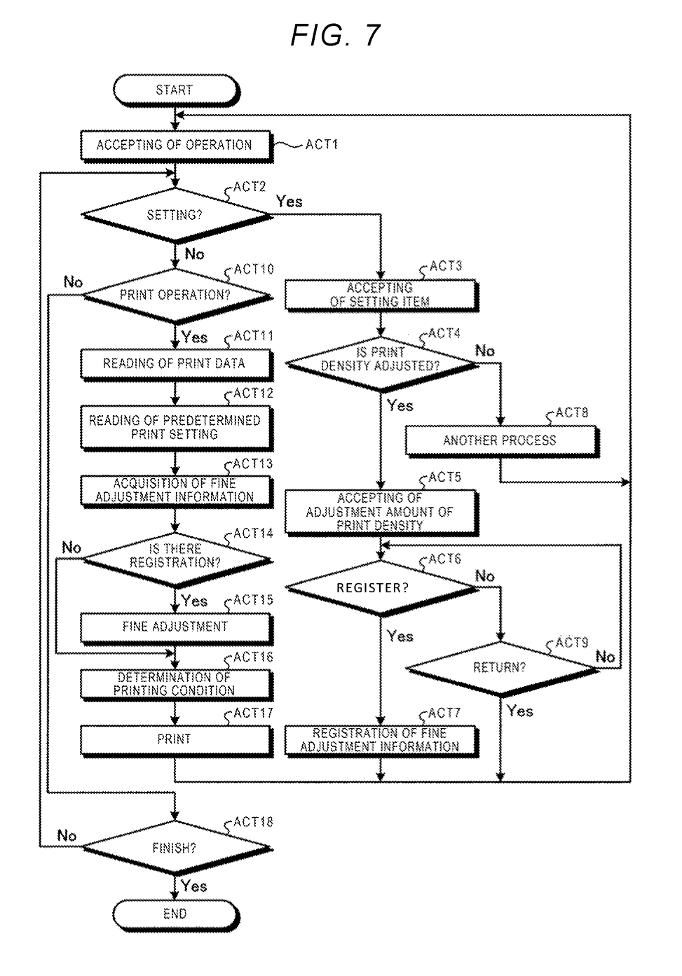

FIG. 7 is a flowchart illustrating an example of an operation of the label printer 1. First, the print control unit 203 instructs the display control unit 201 to display the operation screen and accepts an operation by the user from the input accepting unit 202 (Act 1).

When the operation of the setting mode is accepted (Act 2: Yes determination), the print control unit 203 instructs the display control unit 201 to display setting items that can be set by the user, and accepts an operation by the user from the input accepting unit 202 (Act 3).

Subsequently, when an operation of an item for adjusting the print density in the setting items is accepted (Act 4: Yes determination), the print control unit 203 instructs the display control unit 201 to display an adjustment screen of the print density, and accepts an operation by the user from the input accepting unit 202 (Act 5). For example, the print control unit 203 accepts the number of times the up button and the down button are operated on the adjustment screen for finely adjusting a density value in predetermined steps, by one step, thereby converting the density value to an up width or a down width. The up width and the down width are adjustment widths (fine adjustment values) of positive and negative values, respectively.

Subsequently, when the print control unit 203 accepts an operation of a registration button (Act 6: Yes determination), the print control unit 203 instructs the communication control unit 204 to register the fine adjustment value to the tag 71 (Act 7). Based on the instruction, the communication control unit 204 transmits to the tag 71 the fine adjustment information (identification information about the mounted roll paper 90 and fine adjustment value obtained in Act 5) and registers the fine adjustment information to the fine adjustment information D2 of the tag 71. After Act 7, the print control unit 203 proceeds to Act 1.

Moreover, when the print control unit 203 accepts an operation other than an item for adjusting the print density in the setting items (Act 4: No determination), the print control unit 203 performs a process corresponding to the accepting item (Act 8) and proceeds to Act 1.

When the print control unit 203 does not accept the operation of the registration button (Act 6: No determination) and accepts an operation of a return button (Act 9: Yes determination), the print control unit 203 proceeds to Act 1. If the print control unit 203 does not accept the operation of the return button (Act 9: No determination), the print control unit 203 waits until there is the operation of the registration button or the return button.

When the print control unit 203 accepts the print operation (Act 10: Yes determination) instead of the operation of the setting mode (Act 2: No determination), the print control unit 203 performs the next printing.

First, the print control unit 203 reads the print data of a destination specified by the user (Act 11). For example, when the print data of the USB memory is specified by the user, the print control unit 203 reads the print data from the USB memory.

Subsequently, the print control unit 203 reads the predetermined print setting corresponding to the combination of the ink ribbon unit 80 and the roll paper 90 to be mounted, from the print setting information of the ROM 102 (Act 12).

Subsequently, the print control unit 203 instructs the communication control unit 204 to acquire the fine adjustment information D2 from the tag 71 (Act 13). The communication control unit 204 causes the tag 71 to transmit the fine adjustment information D2 and acquires the fine adjustment information D2.

Subsequently, the print control unit 203 determines whether or not the identification information about the mounted roll paper 90 is registered in the acquired fine adjustment information D2 (Act 14).

When the identification information is registered (Act 14: Yes determination), the print control unit 203 corrects the value of the print density of the predetermined print setting by the fine adjustment value associated with the identification information about the roll paper 90 in the fine adjustment information D2 (Act 15).

Then, the print control unit 203 determines printing conditions from the corrected print setting (Act 16) and performs printing under the printing conditions (Act 17).

On the other hand, when the identification information is not registered (Act 14: No determination), the print control unit 203 sets the value of the print density to an original value of the print setting, that is, to the predetermined print setting, determines the printing conditions from the predetermined print setting in Act 16, and performs printing under the predetermined printing conditions in Act 17.

After printing, the print control unit 203 proceeds to Act 1.

When the print control unit 203 accepts an end operation (Act 18: Yes determination) without accepting the print operation (Act 10: No determination), the print control unit 203 causes the power supply to be turned of f by ending the process. When the print control unit 203 also does not accept the ending operation (Act 18: No determination), the print control unit 203 proceeds to Act 2 and performs same determining process until there is any button operation.

In an embodiment, the identification information D1 and the identification information D3 of the ink ribbon unit 80 and the roll paper 90 are stored in the tags 71 and 72 in advance, respectively. If the identification information is not stored in the tags 71 and 72, when the ink ribbon unit 80 and the roll paper 90 are mounted on the label printer 1, the identification information D1 and D3 are written to the tags 71 and 72 by the RFID reader/writer 113.

Specifically, for the respective identification information about the ink ribbon unit 80 and the roll paper 90, for example, a catalogue list of the respective identification information is displayed on the display unit 11, and is selected by the user in the operation unit 12. Identification information printed on a product package may be manually input by the user in the operation unit 12, or a barcode printed on the product package maybe input by barcode scan. Shapes and sizes of the ink ribbon unit 80 and the roll paper 90 which are mounted, and the like are detected by a sensor, and the identification information may be acquired from a corresponding list or the like. Acquired respective identification information is written by the communication control unit 204 by controlling the RFID reader/writer 113. Specifically, the communication control unit 204 controls the RFID reader/writer 113 as the writing unit 204a, writes the identification information about the ink ribbon unit 80 in the tag 71, and writes the identification information about the roll paper 90 in the tag 72.

In an embodiment, the identification information D1 and the identification information D3 about the ink ribbon unit 80 and the roll paper 90 are stored in the tags 71 and 72, respectively, but if the label printer 1 can recognize the respective identification information about the ink ribbon unit 80 and the roll paper 90 which are mounted without communication with the tag 71 and the tag 72, the respective identification information may be excluded from the data configurations of the tag 71 and the tag 72. However, even in the case, the tag 71 and the tag 72 can be individually identified so that the label printer 1 can identify the tag 71 of the ink ribbon unit 80 and the tag 72 of the roll paper 90.

In the aforementioned embodiments, the fine adjustment information D2 is stored in the tag 71 of the ink ribbon unit 80, but the configuration is not limited to the embodiments. The fine adjustment information D2 may be stored in the tag 72 of the roll paper 90 instead of the tag 71 of the ink ribbon unit 80. The fine adjustment information D2 may be stored in the tag 71 and the tag 72 of the ink ribbon unit 80 and the roll paper 90, respectively.

In addition, in the above embodiments, an example of application to a thermal transfer type label printer is illustrated, but the embodiments are not limited to the thermal transfer type label printer. In addition, the example may be applied to an ink jet type, a heat sensitive type, or the like. The example is not limited to the label printer but maybe applied to other printers.

As described above, if the label printer 1 of the aforementioned embodiments adjusts the print density from the predetermined print setting, the information indicating the combination of the ink ribbon unit 80 and the roll paper 90 which are mounted, and an adjustment value are stored in association with the tag 71 or the tag 72 of the ink ribbon unit 80 or the roll paper 90. Therefore, even when one or both of the ink ribbon unit 80 and the roll paper 90 is changed, if setting indicating the combination of the ink ribbon unit 80 and the roll paper 90 after the change is previously registered in the tag 71 or the tag 72, the adjustment value thereof can be read from the tag 71 or the tag 72, and setting of the print density can be automatically adjusted to adjusted setting. Therefore, it is possible to reduce a burden of the adjustment of the print setting including the print density by the user.

For example, in a company or the like, whenever the label is reattached, there is a scene in which the roll paper and the ink ribbon unit which are used for printing are changed for a corresponding combination, and printing is performed on the changed label. In this case, since the fine adjustment information about the print density previously adjusted by the combination is read out from the roll paper or the ink ribbon unit, whenever they are changed, the fine adjustment information about the previously adjusted print density of each combination is read out. Therefore, it is possible to save time and labor for re-adjusting the print density once previously adjusted, thereby reducing the burden on the user.

The label printer 1 of the aforementioned embodiments is not limited to one in which the identification information is written in the tag 71 and the tag 72 as the ink ribbon unit 80 and the roll paper 90, and it is also possible to mount and use the tag 71 and the tag 72 in which the identification information is not written. Therefore, in the label printer 1 of the embodiments, if the tag 71 and the tag 72 are disposed in the ink ribbon unit 80 and the roll paper 90, it is possible to easily start using the function.

### Modification Example 1

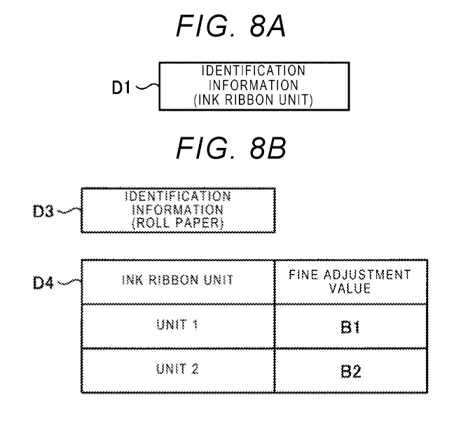

In Modification example 1, a modification example of data stored in a tag 71 and a tag 72 is illustrated. FIGS. 8A and 8B are diagrams illustrating an example of data stored in the tag 71 and the tag 72 of Modification example 1. FIG. 8A illustrates a configuration of the data stored in the tag 71 and FIG. 8B illustrates a configuration of the data stored in the tag 72.

In Modification example 1, fine adjustment information is stored not in the tag 71 of an ink ribbon unit 80 but in the tag 72 of a roll paper 90. A fine adjustment information D4 of FIG. 8B illustrates a configuration of data when the fine adjustment information is stored in the tag 72 of the roll paper 90. The fine adjustment information D4 includes identification information indicating a type of the ink ribbon unit 80 which is mounted in combination with the roll paper 90 with respect to a label printer 1, and information in association with a fine adjustment value which is finely adjusted by using a function of a setting mode by a user in a state where the ink ribbon unit 80 and the roll paper 90 are mounted. When the roll paper 90 and the ink ribbon unit 80 of a new combination are mounted, the fine adjustment information about the ink ribbon unit 80 of the new combination is registered here.

FIG. 8B illustrates an example of registration when the fine adjustment value is registered up to two types of the ink ribbon units 80 in the fine adjustment information D4 as an example. A fine adjustment value “B1” is associated with the type of the ink ribbon unit 80 of “unit 1”. In addition, a fine adjustment value “B2” is associated with the type of the ink ribbon unit 80 of “unit 2”. After that, when another ink ribbon unit 80 is mounted, information indicating a corresponding relationship between the ink ribbon unit 80 and the fine adjustment value is additionally registered.

In Modification example 1, an operation of the label printer 1 is such that a reading destination and a writing destination of the fine adjustment information D2 are changed from the tag 71 of the ink ribbon unit 80 to the tag 72 of the roll paper 90 in the operation (see FIG. 7) of the label printer 1 of the embodiments discussed above. Other than that, since it is substantially the same as the operation of the label printer 1 of the embodiments, further explanation will be omitted here.

### Modification Example 2

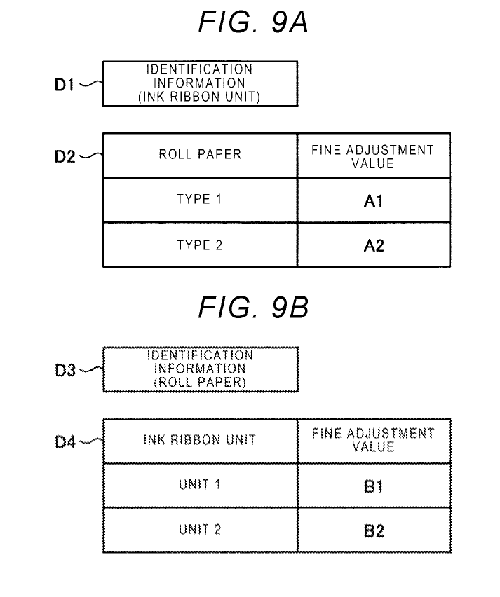

In Modification example 2, another modification example of data stored in a tag 71 and a tag 72 is illustrated. FIGS. 9A and 9B are diagrams illustrating an example of data stored in the tag 71 and the tag 72 of Modification example 2. FIG. 9A illustrates a configuration of the data stored in the tag 71 and FIG. 9B illustrates a configuration of the data stored in the tag 72.

FIG. 9A illustrates the same data configuration as that of FIG. 6A. In addition, FIG. 9B illustrates the same data configuration as that of FIG. 8B. That is, in Modification example 2, the fine adjustment information D2 and the fine adjustment information D4 are respectively stored in the tag 71 of the ink ribbon unit 80 and the tag 72 of the roll paper 90.

Moreover, in fine adjustment values (A1, A2, . . . ) of the fine adjustment information D2 and fine adjustment values (B1, B2, . . . ) of the fine adjustment information D4 illustrated in FIGS. 9A and 9B, the same value is used for the same combination of the ink ribbon unit 80 and the roll paper 90.

In Modification example 2, an operation of the label printer 1 is such that the tag 72 of the roll paper 90 is added as a reading destination and a writing destination of the fine adjustment information D2 in the operation (see FIG. 7) of the label printer 1 of the embodiments discussed above. That is, when the fine adjustment information is read, the fine adjustment information D2 of the tag 71 and the fine adjustment information D4 of the tag 72 are read. When the fine adjustment information is written, it is written in the fine adjustment information D2 of the tag 71 and the fine adjustment information D4 of the tag 72. The other operation is substantially the same as the operation of the label printer 1 of the embodiments. Therefore, further explanation will be omitted here.

In Modification example 2, since the fine adjustment information is written in both the tag 71 of the ink ribbon unit 80 and the tag 72 of the roll paper 90, even when the fine adjustment information is not transmitted from both the tag 71 and the tag 72, it is possible to acquire the fine adjustment information. It is possible to use the label printer of Modification example 2 and the label printer illustrated in Modification example 1 together. In this case, it is possible to acquire the fine adjustment information by mounting the roll paper 90 used in the label printer illustrated in the embodiments discussed above or the ink ribbon unit 80 used in the label printer illustrated in Modification example 1.

Various programs used in the label printer of the embodiments are recorded and provided in computer-readable recording media such as a CD-ROM, a flexible disk (FD), a CD-R, a Digital Versatile Disk (DVD), and the like in installable format or executable format file, and may be read and executed by the ROM (flash ROM) of the label printer or the like.

The program may be stored on a computer connected to a network such as the Internet and may be provided by being downloaded via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer configured to connect with a detachable ink unit and a printing medium wound around a core, the printer comprising:
a wireless tag reader and writer configured to communicate with a wireless tag;
an input device configured to accept an input from a user; and
a controller configured to control the wireless tag reader and writer to, when the input device accepts the input for adjusting a setting of the ink unit, store in at least one of a first tag included in the ink unit and a second tag included in the core, combination information indicating a combination of the ink unit and the printing medium that are attached to the printer and adjustment information indicating the setting.

2. The printer according to claim 1, wherein the controller is configured to:
control the wireless tag reader and writer to retrieve the stored combination information and the stored adjustment information; and
carry out printing on the printing medium based on the retrieved combination information and the retrieved adjustment information.

3. The printer according to claim 1, wherein
when the ink unit and the printing medium are attached to the printer for the first time, the controller controls the wireless tag reader and writer to store first identification information for the ink unit in the first tag and second identification information for the printing medium in the second tag.

4. The printer according to claim 3, wherein
when the input device accepts the input for adjusting the setting, the controller controls the wireless tag reader and writer to store the combined information and the adjustment information that include the first and the second identification information each retrieved from the first and the second tag.

5. The printer according to claim 1, wherein
first identification information for the ink unit and second identification information for the printing medium are each stored in the first and the second tag before the ink unit and the printing medium are attached to the printer.

6. The printer according to claim 5, wherein
when the input device accepts the input for adjusting the setting, the controller controls the wireless tag reader and writer to store the combined information and the adjustment information that include the first and the second identification information each retrieved from the first and the second tag.

7. The printer according to claim 1, wherein
the controller is configured to store the adjustment information in both the first and the second tag.

8. The printer according to claim 1, wherein
the adjustment information indicates the setting for a print density.

9. The printer according to claim 8, wherein
the setting represents a positive or a negative adjustment value of the print density.

10. The printer according to claim 1, wherein
the printing medium is a label, and
the printer comprises a port configured to issue the label.

11. A method carried out by a printer configured to connect with a detachable ink unit and a printing medium wound around a core, the method comprising:
accepting an input to adjust a setting of the ink unit from a user; and
storing in at least one of a first tag included in the ink unit and a second tag included in the core, combination information indicating a combination of the ink unit and the printing medium that are attached to the printer and adjustment information indicating the setting.

12. The method according to claim 11, further comprising:
retrieving the stored combination information and the stored adjustment information; and
carrying out printing on the printing medium based on the retrieved combination information and the retrieved adjustment information.

13. The method according to claim 11, further comprising:
when the ink unit and the printing medium are attached to the printer for the first time, storing first identification information for the ink unit in the first tag and second identification information for the printing medium in the second tag.

14. The method according to claim 13, further comprising:
when the input for adjusting the setting is accepted, storing the combined information and the adjustment information that include the first and the second identification information each retrieved from the first and the second tag.

15. The method according to claim 11, wherein
first identification information for the ink unit and second identification information for the printing medium are each stored in the first and the second tag before the ink unit and the printing medium are attached to the printer.

16. The method according to claim 15, further comprising:
when the input for adjusting the setting is accepted, storing the combined information and the adjustment information that include the first and the second identification information each retrieved from the first and the second tag.

17. The method according to claim 11, wherein
the adjustment information is stored in both the first and the second tag.

18. The method according to claim 11, wherein
the adjustment information indicates the setting for a print density.

19. The method according to claim 18, wherein
the setting represents a positive or a negative adjustment value of the print density.

20. The method according to claim 11, wherein
the printing medium is a label, and
the printer comprises a port configured to issue the label.
